(19) United States
(12) Patent Application Publication
(10) Pub. No.: US 2005/0261010 A1
(43) Pub. Date: Nov. 24, 2005

(54) Integrated telecommunications/office automation apparatus, system, and computer program product

(75) Inventor: Thomas F. Anglero, Oslo (NO)

Correspondence Address: OBLON, SPIVAK, MCCLELLAND, MAIER & NEUSTADT, P.C., 1940 DUKE STREET, ALEXANDRIA, VA, 22314, US

(73) Assignee: TELENOR ASA, Fornebu (NO)

(21) Appl. No.: 10/921,971

(22) Filed: Aug. 20, 2004

Related U.S. Application Data
(60) Provisional application No. 60/564,575, filed on Apr. 23, 2004.

(51) Int. Cl. H04Q 7/20

(52) U.S. Cl. 455/466

(57) ABSTRACT

An apparatus, system, and computer program product including a plug-in that allows for messaging from within an office automation software environment such that telecommunications services providers can take advantage of an emerging model of computing—web services—to boost the use of their services and drive new revenue streams.

### BACKGROUND OF INVENTION

1. Field of Invention

A method, system, apparatus, and computer program product for providing direct access to telecommunications services from within applications with word processing or text processing capabilities. One embodiment of the invention relates to a plug-in for office suite type applications where the plug-in identifies character strings in a document and is capable of accessing a telecommunication service using the character string as address information. The invention provides a close integration of office applications and telecommunications in a manner that will result in greater convenience for the user and will boost use of telecommunications services and drive revenues for telecommunications services providers.

2. Discussion of the Background Art

Current office automation software (e.g. office suites, word processing, spreadsheets, etc) operate separately from internet-enabled services such as web-based or application based telecommunications services. In particular, office applications have offered a certain amount of integration between them in the sense that data created in one application can be embedded in a document created in another application, and the embedded data will be sent back to the original application for further modification or editing in the original application if the user clicks on the part of the document containing the embedded data. Similarly, some applications are capable of accessing e-mail client programs and sending a native document to such a client such that the user can enter the e-mail address of a recipient and send the document by e-mail.

Web pages have traditionally relied on hyperlinks to associate text with individual resources on a file system, Web server, or e-mail server. Recently, however, some applications have been provided with functionality that enables the identification of certain portions of data within a document, particularly character strings, and to provide these portions of data with so-called tags that contain information describing some characteristic of the data. As an example, Microsoft Corp. has provided such functionality in the latest version of their Office applications. In Office this functionality is known as Smart Tags. To add smart tags, an author can use a text editor such as Notepad or an HTML editor such as Microsoft FrontPage® 2002. In one embodiment, users may add smart tags by installing them (running an installation program for the new smart tag), or enabling them in the options menu of the Office application if the Smart Tag is already installed.

To view smart tags, users must have predetermined software installed on their computers: (e.g., Office XP, Microsoft Internet Explorer 5 or later) and the appropriate smart tag dynamic link library (DLL) or smart tag Extensible Markup Language (XML) list description file. Smart Tags can be configured by the user to identify character strings defined by the user, and certain actions can be associated with each type of Smart Tag. When a user clicks on a character string tagged with a Smart Tag in a Microsoft Office document, a short-cut to a web or other address is activated. In one embodiment, the developer of the Smart Tag determines the character strings to be recognized

Implementations of Smart Tags have been limited to recognition of names, email addresses and other contact information for integration with applications such as Outlook. Smart Tags have also been used to recognize codes/IDs, such as product codes, for adding more information about an item (product) in a document. However, Smart Tags have not been used with telecommunications functions. That is, if a user operating a word processing program wants to exercise a telecommunications function (e.g., send a Short Message Service (SMS) message), a separate application must be activated. Furthermore, conventional implementations of Smart Tags do not directly interact with telecommunications services.

What is required, as discovered by the present inventors, is a method and apparatus that enables direct access to telecommunications services (e.g., through recognition of a telephone number) from within applications with word processing or text processing capabilities so as to provide greater convenience for the user (e.g., direct calling and sending of SMS messages) and to boost use of telecommunications services and drive revenues for telecommunications services providers.

### SUMMARY OF THE INVENTION

The present invention expands a user's possibilities for accessing telecommunications services without leaving his office application environment. This is achieved through the use of a plug-in in the office application capable of detecting any character string in a document when said character string exhibits a pattern consistent with a telephone number and tagging this character string accordingly. The tag is associated with messaging software that will open when a user clicks on the tagged character string, and the character string will be sent to the messaging software as a parameter. The messaging software will open with the character string in the “to” field. The user will then be able to simply enter his message and click send. The messaging software will be pre-configured to hold any log-in information necessary in order to access the telecommunications services. The log-in information will typically include the users phone number, and the telecommunications service provider will be able to charge the communication to this number.

The web-services model uses standardized programming languages such as extensible mark-up language (XML) to make integrating disparate systems cheaper and more immediate. The present invention allows users to access elements of its fixed, mobile, online and satellite broadcasting services from within applications such as Word, Excel, Outlook and PowerPoint via this plug-in, something that has not been achieved to date. A customer composing a letter, for example, can query the operator's directory service, find someone's phone number and then send that person an MMS with the letter attached, all from within Microsoft's Word 2003. Revenue is generated from the standard charges that the telecommunications services provider applies for sending MMS or SMS messages. Other services, such as the operator's online news service, TV guide and directory services, are free to access. The present invention boosts consumer use of a service provider's free and fee-based services and others, such as an e-commerce account, and attract new subscribers in its domestic market. The plug-in has similar applicability to a service provider's business customers. The plug-in allows for international telecommunications access as well.

### BRIEF DESCRIPTION OF THE DRAWINGS

FIGS. 1a and 1b are screen shots of one embodiment of the present invention;

FIG. 2 is a flow chart of software interactions according to one embodiment of the present invention; and

FIG. 3 is a block diagram of a computing device associated with an embodiment of the present invention.

### DETAILED DESCRIPTION OF THE INVENTION

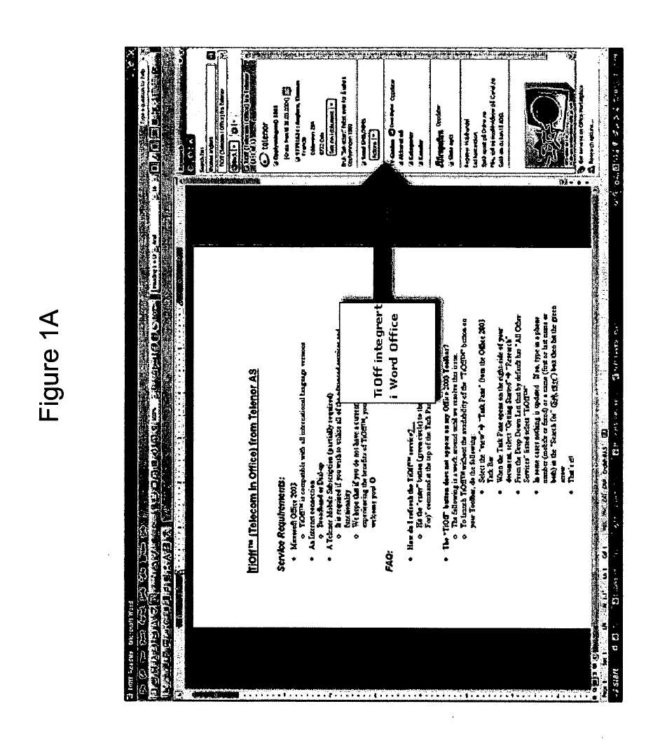

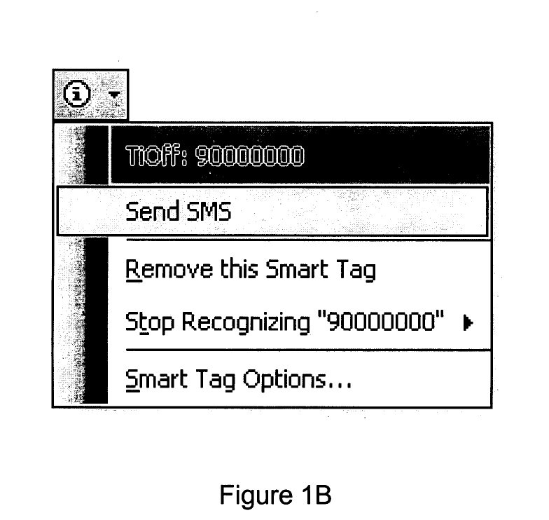

FIG. 1a is a screen snap shot of one embodiment of the present invention. In the center of the desktop 1 is a display 2 of a word processing document. To the right of the display 2 is a research pane 3 according to one embodiment of the invention. The research pane 3 is a gateway through which an operator of a word processing display 2 can interact with a variety of telecommunications services. These services include: a) white pages search; b) a map-it function; c) a Short Message Service (SMS) function; d) a news function; e) a television/radio guide; and f) an asymmetric digital subscriber line (ADSL) checking function. In addition, links to external websites may be provided.

In one embodiment, the application of the present invention initiates either through automatic recognition of the presence of a pre-encoded in the word processing document or via user selection from the research pane. If initiating via the research pane, a drop down menu is provided as shown in FIG. 1b. When a telephone number is detected within the word processing document, the word/pattern is tagged by the plug-in and the operator is able to select from options such as a) send SMS; b) remove this smart tag; c) stop recognizing the number; and a variety of smart tag options. Examples of smart tag options include performing a directory search from the phone number provided, setting up a phone call between a mobile/fixed phone to the user's mobile, displaying a list of services in the form of webpage links to a host telecommunications service provider's web pages from within the SmartTag, and querying the identified phone number to determine if broadband services are available at that phone number.

In one embodiment, the present invention uses XML capabilities built into the Office 2003 applications to integrate with these Office applications with fixed, mobile and online services, which have been made available as web services using XML. The plug-in, known as SmartTag, is based on standard XML technology. Details about SmartTag implementation are provided by MICROSOFT at http://www.microsoft.com/downloads/details.aspx?FamilyID=c6189658-d915-4140-908a-9a0114953721&displaylang=en. In other embodiments, the present invention is adapted to other Microsoft or non-Microsoft office automation environments.

In one embodiment, the present invention enables a user to use MICROSOFT Smart Tags from within Office to access services over the Internet from a telecommunications services provider. If the Smart Tag identifies a name/phone number, the Smart Tag will offer direct access to an application from which SMS can be sent using the telecommunications services provider's services. In another embodiment, the application verifies the name/number is associated with a phone number in the users address book before offering direct access.

In one embodiment, the Smart Tag of the present invention launches the SMS application using a .NET API call for starting .exe files. The recognized phone number is passed as a parameter to the .exe file. The code for this is systems.diagnostics.process.start (smsappexe, phonenr). The Office environment allows registered Smart Tags access to document data. The Smart Tag is continuously fed the contents of the document while the user enters it. Using the functionality of regular expressions in the NET API, the present invention notifies the Office application so that the text can be marked as recognized by a Smart Tag. When the user selects the Smart Tag from the marked text, the SMS application is launched and the text (the recognized phone number) is passed to the SMS application. The SMS application forwards to a telecommunications gateway.

In other embodiments, additional services are offered upon recognition of a character string. These additional services include MMS (including sending the Office document as an attachment), directory services, and more traditional web services like news, TV guide, weather etc (with the possibility to base the response from these services on context information embedded in Smart Tags).

In another embodiment, the application enables a user to choose to call another person from within an application (using Smart Tags or a Research Pane). The application will communicate with services on the Internet, which again will relay the request to the telecom network. Here a phone call connection between the user's and the other person's telephones will be established and both telephones will ring. Note that while in the first case the application is only sending a message from the Internet to the telecom net, in this second case a connection is established between terminals on the telecom net based on a request from the Internet (telecom signaling over Internet). The call will be connected via the standard Telecom infrastructure, with the Internet as the transport medium for the signal to establish the call on the telecom network.

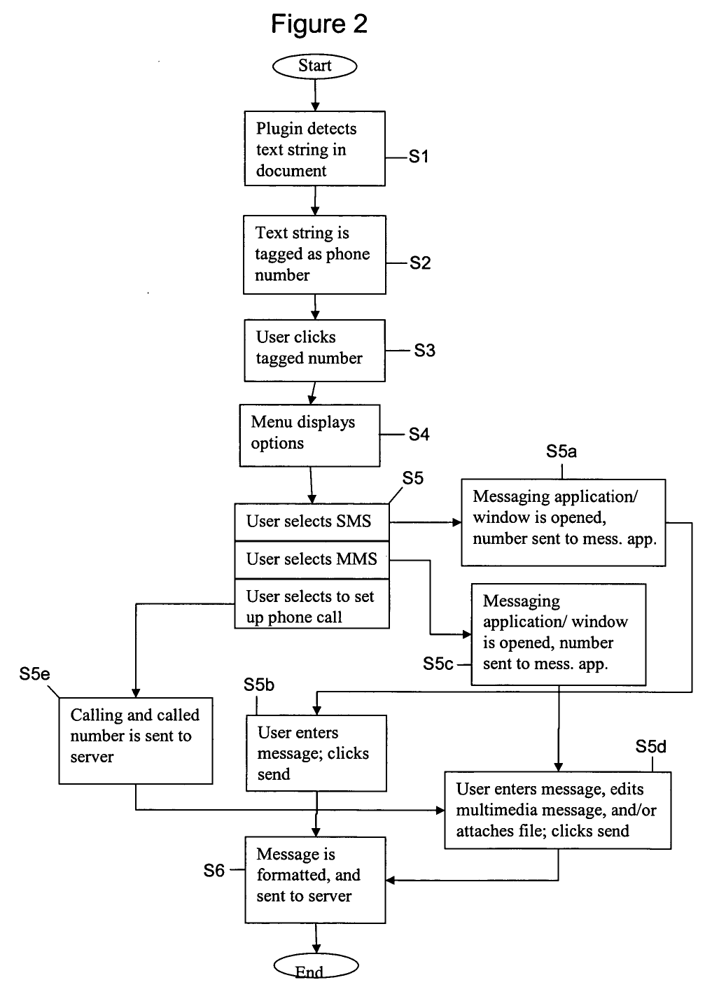

FIG. 2 is a flow chart corresponding to one embodiment of the present invention. When the application is enabled, the process begins when the plug-in detects a predefined character string in the document (step S1). The character string is tagged as a phone number (step S2). The character string may be an actual phone number, an entity's name, an address, or any other nickname/identifier previously determined by the user. The user clicks on the tagged number (step S3). At least one menu of options are displayed (step S4). From the menu of options, the user selects either a) SMS, b) MMS, or c) to set up a phone call (Step S5). If SMS is chosen in step S5, a messaging application/window is opened and the number is sent to the messaging application (step S5A). The user then enters the message and clicks to send (step S5B). If MMS is chosen in step S5, a messaging application/window is opened and the number is sent to the messaging application (step S5C). The user then enters the message, edits the multimedia message or attaches a file, and clicks to send (step S5D). After the user clicks to send in steps S5B or S5D, the message is formatted and sent to a messaging server for forwarding to the destination address (step S6). If the user selected to set up a phone call in step S5, the calling number and called number are sent to a server, and the call is placed (step S5E).

Thus, from within an office automation software environment such as word processor, spreadsheet, presentation package or other applications, telecommunications services can be quickly accessed and exercised.

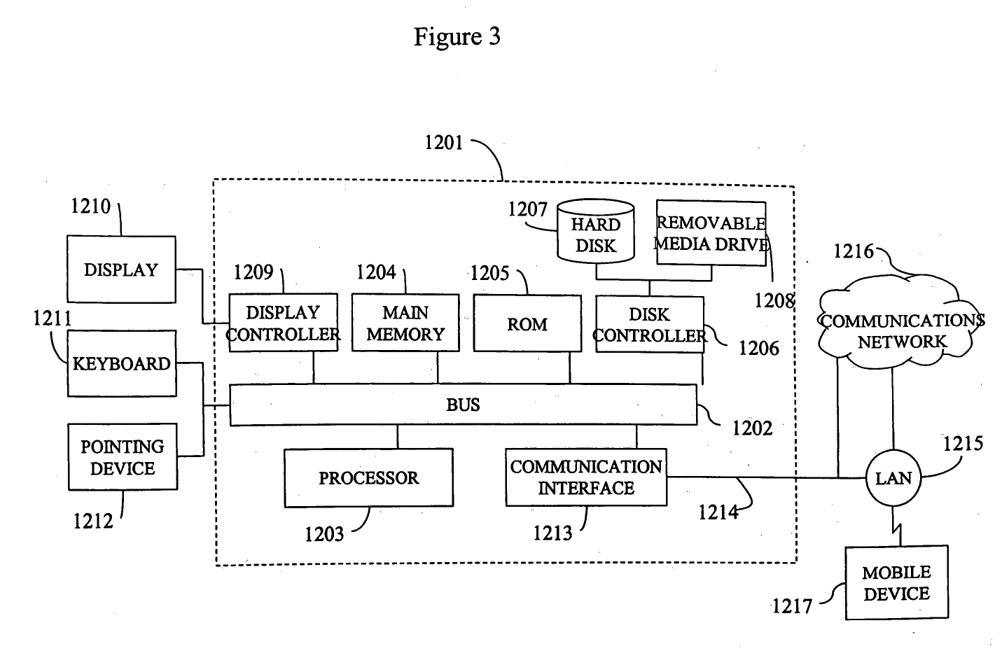

FIG. 3 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Numerous modifications and variations of the present invention are possible in light of the above teachings. It is therefore to be understood that within the scope of the appended claims, the invention may be practiced otherwise than specifically described herein.

1. A method for providing access to telecommunications services from within a computer program application, comprising
identifying a character string in a document opened by the computer program application, said character string representing or associated with a telecommunications address;
tagging said character string to form a tagged character string;
associating said tagged character string with a communications module configured to send one of a command and a message to a telecommunications server over a computer network; and
sending, based on a user input, said tagged character string as a parameter to said communications module.

2. The method of claim 1, further comprising:
sending said one of a command and a message to said telecommunications server.

3. The method of claim 2, further comprising:
sending one of the tagged character string and a telecom address associated corresponding to said tagged character string to said telecommunications server.

4. The method of claim 2, wherein said communications module comprises one of:
a communications module internal to said computer program application; and
a communications module external to said computer program application.

5. The method of claim 4, further comprising:
storing log-in information in said communications module.

6. The method of claim 5, further comprising:
sending said log-in information to said telecommunications server.

7. The method of claim 1, wherein said telecommunications address comprises:
a telephone number.

8. The method of claim 2, wherein said step of sending comprises:
initiating the sending of a SMS message by sending a text message.

9. The method of claim 2, wherein said step of sending comprises:
initiating the sending of a MMS message by sending a multimedia message.

10. The method of claim 1, wherein said character string comprises:
one of a phone number, an entity's name, an address, and a predetermined identifier.

11. The method of claim 1, wherein said step of identifying comprises:
electronically recognizing a predetermined character pattern.

12. The method of claim 12, wherein said step of identifying comprises:
referring to an electronic address book.

13. The method of claim 4, wherein said telephone number comprises:
one of a land-line phone number, a cellular phone number, and a net-phone number.

14. The method of claim 1, wherein said computer program application comprises:
an office automation software environment including one of a word processor, a spreadsheet, and a presentation package.

15. The method of claim 1, wherein said step of identifying comprises one of:
automatically recognizing the presence of a pre-encoded in a word processing document; and
user selection of a pre-encoded word from a research pane.

16. The method of claim 11, wherein said step of user selection comprises:
selecting via a drop down menu.

17. The method of claim 1, further comprising one of:
untagging said tagged character string; and
disassociating said tagged character string from said communications module.

18. The method of claim 1, wherein said command comprises:
a command to initiate a connection between a user's phone and a phone number associated with the identified character string.

19. A system configured to provide access to telecommunications services from within a computer program application, comprising
means for identifying a character string in a document opened by the computer program application, said character string representing or associated with a telecommunications address;
means for tagging said character string to form a tagged character string;
means for associating said tagged character string with a communications module configured to send one of a command and a message to a telecommunications server over a computer network; and
means for sending, based on a user input, said tagged character string as a parameter to said communications module.

20. The system of claim 19, further comprising:
means for sending said one of a command and a message to said telecommunications server.

21. The system of claim 20, further comprising:
means for sending one of the tagged character string and a telecom address associated corresponding to said tagged character string to said telecommunications server.

22. The system of claim 19, wherein said communications module comprises one of:
a communications module internal to said computer program application; and
a communications module external to said computer program application.

23. The system of claim 22, further comprising:
means for storing log-in information in said communications module.

24. The system of claim 23, further comprising:
means for sending said log-in information to said telecommunications server.

25. The system of claim 19, wherein said telecommunications address comprises:
a telephone number.

26. The system of claim 20, wherein said means of sending comprises:
means for sending a SMS message.

27. The system of claim 20, wherein said means of sending comprises:
means for sending a MMS message.

28. The system of claim 19, wherein said character string comprises:
one of a phone number, an entity's name, an address, and a predetermined identifier.

29. The system of claim 28, wherein said means for identifying comprises:
means for electronically recognizing a predetermined character pattern.

30. The system of claim 29, wherein said means of identifying comprises:
means for referring to an electronic address book.

31. The system of claim 25, wherein said telephone number comprises:
one of a land-line phone number, a cellular phone number, and a net-phone number.

32. The system of claim 19, wherein said computer program application comprises:
an office automation software environment including one of a word processor, a spreadsheet, and a presentation package.

33. The system of claim 19, wherein said means of identifying comprises one of:
means for automatically recognizing the presence of a pre-encoded in a word processing document; and
means for user selection of a pre-encoded word from a research pane.

34. The system of claim 33, wherein said means of user selection comprises:
means for selecting via a drop down menu.

35. The system of claim 19, further comprising one of:
means for untagging said tagged character string; and
means for disassociating said tagged character string from said communications module.

36. The system of claim 19, wherein said command comprises:
a command to initiate a connection between a user's phone and a phone number associated with the identified character string.

37. A computer program product, comprising:
instructions for a computer-based device to perform one of the steps recited in claims 1-18.
